(19) United States
(12) Patent Application Publication
(10) Pub. No.: US 2015/0368047 A1
(43) Pub. Date: Dec. 24, 2015

(54) MERCHANDISE CONVEYANCE CONTROL DEVICE AND MERCHANDISE CONVEYANCE CONTROL METHOD

(71) Applicant: Toshiba Tec Kabushiki Kaisha, Tokyo (JP)

(72) Inventor: Tetsuya SADOWARA, Mishima Shizuoka (JP)

(21) Appl. No.: 14/313,325

(22) Filed: Jun. 24, 2014

(51) Int. Cl. B65G 43/08; B07C 5/36

(52) U.S. Cl. CPC B65G 43/08; B07C 5/361; B65G 2811/0673

(57) ABSTRACT

A merchandise conveyance control device includes a detection unit that detects first merchandise information related to conveyance control of a merchandise, and a control unit that controls a timing of when the merchandise is to arrive at a conveyance destination based on the first merchandise information.

### BACKGROUND

Point of sale (POS) systems are connected to transaction systems in stores such as a supermarket. An operator inputs a merchandise code of purchased merchandise, and the like with a scanner or a touch panel which is connected to the POS system. Thus, it is possible to proceed with a transaction process and a merchandise management process through the POS system. After inputting a merchandise code, the operator loads merchandise into a merchandise conveyance belt. The merchandise conveyance belt conveys the merchandise to a bagging area in the order they were loaded. A consumer then bags the merchandise conveyed to the bagging area.

### DESCRIPTION OF THE DRAWINGS

FIG. 1 is a schematic diagram of a POS system according to a first embodiment.

FIG. 2 is a functional block diagram illustrating a portion of the POS system according to the first embodiment.

FIG. 3 is a functional block diagram illustrating a portion of the POS system according to the first embodiment.

FIG. 4 is a flow chart illustrating an example of merchandise conveyance control through a merchandise management system according to the first embodiment.

FIG. 5 is a schematic diagram of a POS system according to a second embodiment.

FIG. 6 is a functional block diagram illustrating a portion of the POS system according to the second embodiment.

FIG. 7 is a functional block diagram illustrating a portion of the POS system according to the second embodiment.

FIG. 8 is a flow chart illustrating an example of merchandise conveyance control through a merchandise management system according to the second embodiment.

### DETAILED DESCRIPTION

As described above, purchased merchandise is conveyed by a merchandise conveyance belt. The order of conveyance depends on an operator's loading order. In general, a consumer attempts to put heavy merchandise and merchandise which is hard to crush in the lower side of a bag and to put light merchandise and merchandise which is easily crushed in the upper side of a bag.

However, as described above, since the purchased merchandise is conveyed in the operator's loading order, the consumer bags the merchandise while sorting the conveyed merchandise. For example, when light and soft articles such as bread are conveyed first and heavy and hard articles such as a beverage in a PET bottle are conveyed later, a consumer waits until the PET bottle is conveyed to a downstream side of a belt, and bags the PET bottle prior to the bread and the like. In other words, it is not possible to sequentially bag the merchandise being conveyed downstream, and thus work efficiency is poor.

Embodiments provide a merchandise conveyance control device and a merchandise conveyance control method which are capable of contributing to the improvement of work efficiency such as bagging of merchandise.

According to an embodiment, a merchandise conveyance control device includes a detection unit that detects first merchandise information related to conveyance control of a merchandise, and a control unit that controls a timing of when the merchandise is to arrive at a conveyance destination based on the first merchandise information.

In this embodiment, a description will be made with the assumption that a POS system is an example of a merchandise management system.

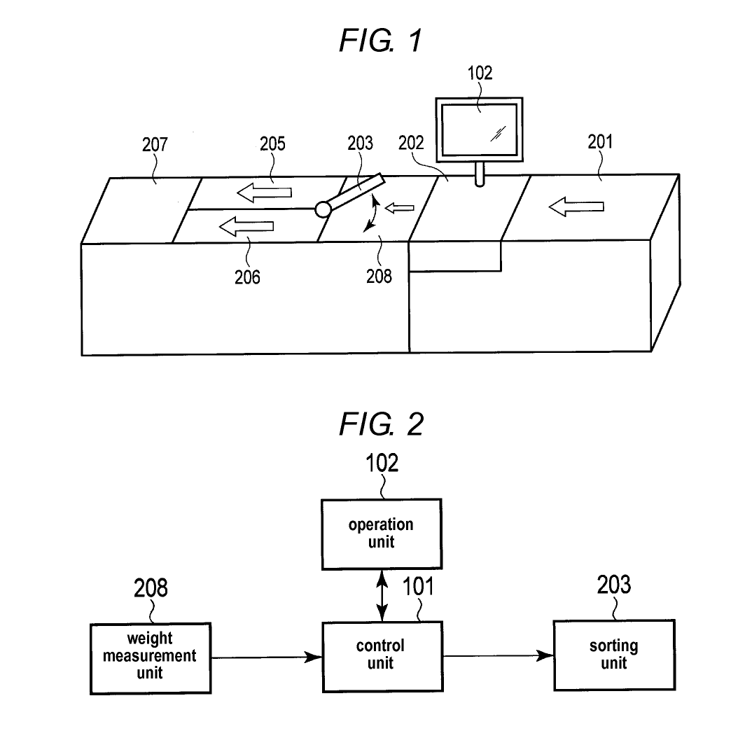

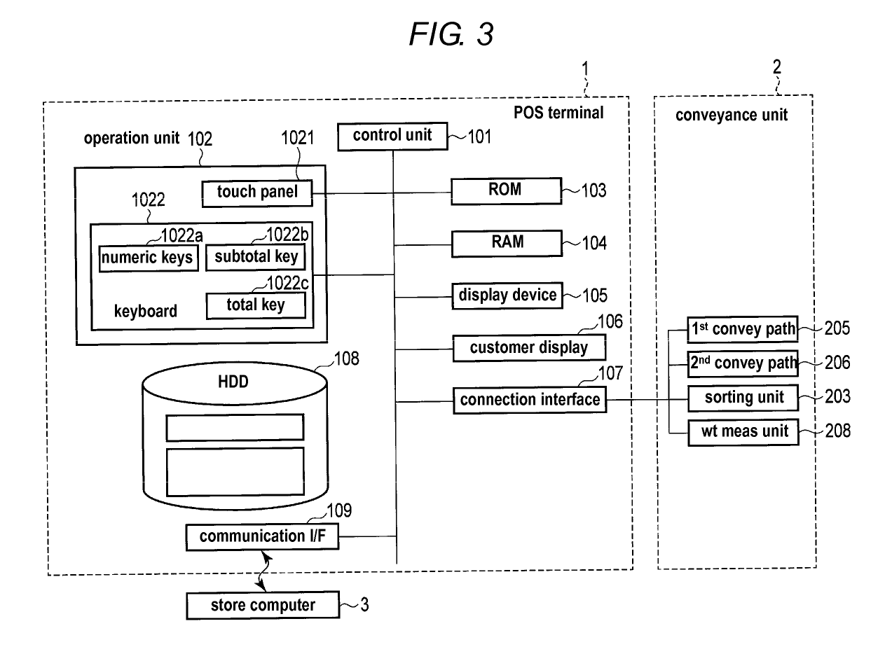

FIG. 1 is a schematic diagram of a POS system according to a first embodiment. FIG. 2 is a functional block diagram illustrating a portion of the POS system according to the first embodiment. FIG. 3 is a functional block diagram illustrating a portion of the POS system according to the first embodiment.

The POS system illustrated in FIGS. 1 to 3 includes a POS terminal 1, a conveyance unit 2, and a store computer 3. The POS terminal 1 includes a control unit 101, an operation unit 102, a read only memory (ROM) 103, a random access memory (RAM) 104, a display device 105, a customer display device 106, a connection interface 107, an HDD 108, and a communication interface 109. The operation unit 102 includes a touch panel 1021 and a keyboard 1022. The keyboard 1022 includes a numeric keypad 1022a in which numerals such as “1”, “2”, “3” . . . and a multiplication operator “×” are displayed on an upper surface thereof, a sub-total key 1022b, and a total key 1022c. The control unit 101 includes a central processing unit (CPU). The HDD 108 stores various programs and a PLU file (merchandise database).

The conveyance unit 2 includes a pre-purchase merchandise conveyance unit 201, a transaction area 202, a sorting unit 203, a sorting area 204, a first conveyance path 205, a second conveyance path 206, a bagging area 207, and a weight measurement unit 208.

When a merchandise name and a merchandise image, which are displayed on the touch panel 1021 of the operation unit 102, are selected by an operator, the operation unit 102 inputs a merchandise code corresponding to the selected merchandise name and merchandise image to a merchandise management system (e.g., stores them in the HDD 108). In addition, the operation unit 102 receives inputs of various instructions for the merchandise management system, and inputs the received instructions to the merchandise management system (e.g., inputs them into the control unit 101). Furthermore, a scanner connected to the merchandise management system may be used in addition to the input of the merchandise code from the operation unit 102. The scanner reads a merchandise code printed on merchandise and inputs the read merchandise code to the merchandise management system (e.g., stores it in the HDD 108).

For example, the pre-purchase merchandise conveyance unit 201 starts conveyance based on a conveyance start instruction input from the operation unit 102 or merchandise detection through a merchandise detection sensor, and conveys pre-purchase merchandise to the transaction area 202. The sorting unit 203 sorts merchandise loaded into the sorting area 204 to any one of the first conveyance path 205 and the second conveyance path 206 based on a control signal from the control unit 101. The first conveyance path 205 conveys the sorted merchandise to the bagging area 207 at a first conveyance speed. The second conveyance path 206 conveys the sorted merchandise to the bagging area 207 at a second conveyance speed which is lower than the first conveyance speed. The sorting of the merchandise using the sorting unit 203 and the conveyance of the merchandise through the first conveyance path 205 or the second conveyance path 206 achieve variable control of a timing when merchandise arrives at a conveyance destination, which will be described later.

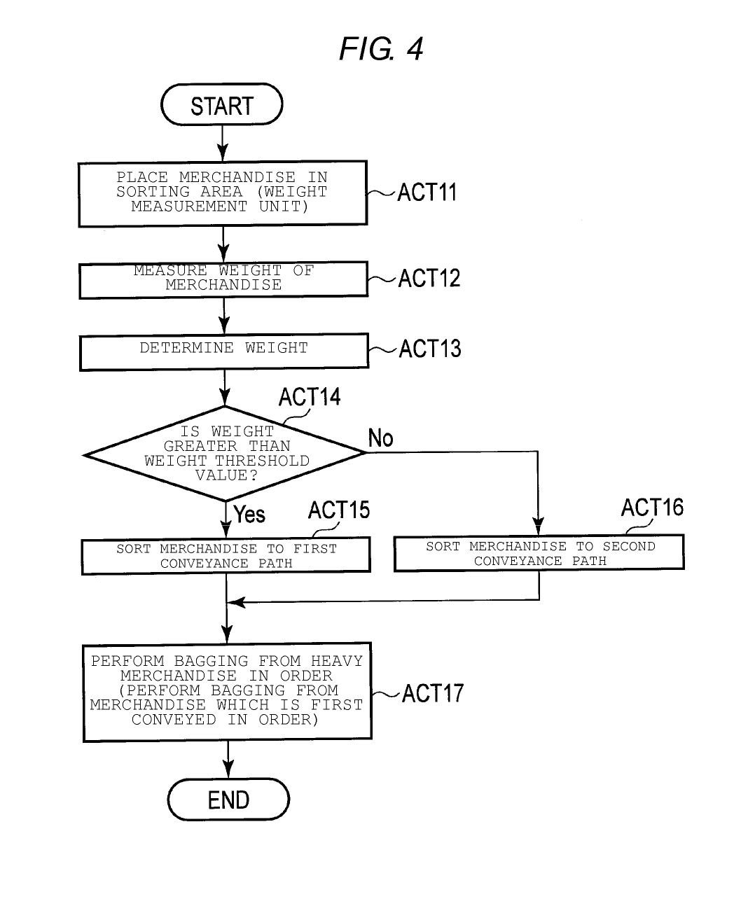

FIG. 4 is a flow chart illustrating an example of merchandise conveyance control through the merchandise management system according to the first embodiment.

For example, an operator inputs a merchandise code of each merchandise item purchased by a consumer through the operation unit 102 to carry out the transaction. The operator places merchandise having a merchandise code inputted, in the sorting area 204 (the weight measurement unit 208) (ACT 11). The weight measurement unit 208 measures the weight of the merchandise placed in the sorting area (ACT 12), and outputs weight measurement information (first merchandise information) of the merchandise.

The control unit 101 controls the conveyance unit 2 based on the first merchandise information. The control unit 101 determines whether the weight of the merchandise is greater than a weight threshold value or is equal to or less than the weight threshold value based on the first merchandise information indicating the weight of the merchandise, with reference to the weight threshold value stored in the HDD 108 (ACT 13), and controls a sorting operation through the sorting unit 203 in accordance with the determination result.

When the weight of the merchandise is greater than the weight threshold value (ACT 14, YES), the control unit 101 outputs a first control signal for controlling the sorting to the first conveyance path 205 through the sorting unit 203 of the conveyance unit 2. Thus, the sorting unit 203 sorts the merchandise of the sorting area to the first conveyance path 205 (ACT 15), and the first conveyance path 205 conveys the sorted merchandise to the bagging area 27.

When the weight of the merchandise is equal to or less than the weight threshold value (ACT 14, NO), the control unit 101 outputs a second control signal for controlling sorting to the second conveyance path 206 through the sorting unit 203 of the conveyance unit 2. Thus, the sorting unit 203 sorts the merchandise of the sorting area to the second conveyance path 206 (ACT 16), and the second conveyance path 206 conveys the sorted merchandise to the bagging area 27.

As described above, the merchandise is selectively conveyed on the first conveyance path 205 and the second conveyance path 206 by the operation of the sorting unit 203, and thus it is possible to variably control a timing when the merchandise arrives at a conveyance destination. In other words, heavy merchandise is conveyed to the bagging area 27 prior to light merchandise, and thus a consumer may bag the heavy merchandise prior to the light merchandise (ACT 17).

Meanwhile, in this embodiment, although a case where the POS terminal 1 includes the control unit 101 and the operation unit 102 is described, a configuration in which the conveyance unit 2 includes the control unit 101 and the operation unit 102 may be employed. In this case, it is possible to control the sorting unit 203 even with the single conveyance unit 2, which allows this embodiment to be achieved.

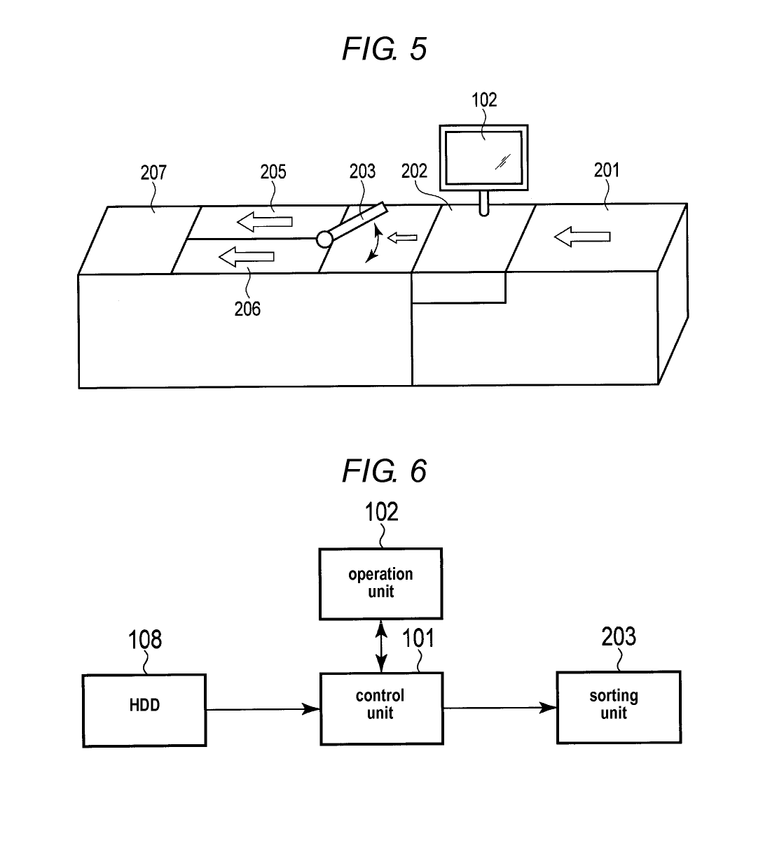

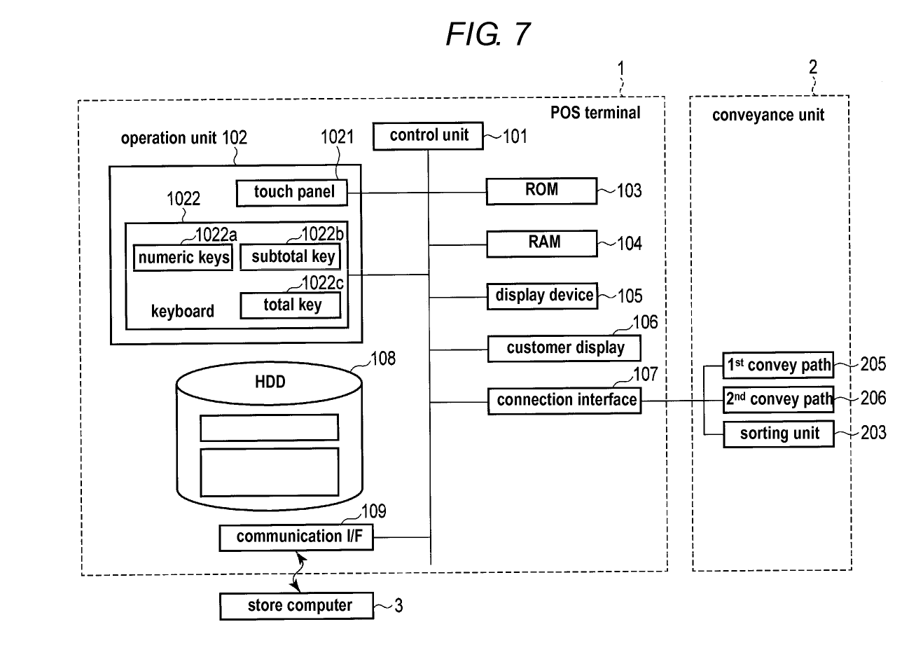

FIG. 5 is a schematic diagram of a POS system according to a second embodiment. FIG. 6 is a functional block diagram illustrating a portion of the POS system according to the second embodiment. FIG. 7 is a functional block diagram illustrating a portion of the POS system according to the second embodiment.

The second embodiment will be described focusing on the differences from the first embodiment, and the description of common parts will be omitted appropriately. In the first embodiment, merchandise is sorted based on the weight measurement information (first merchandise information) of the merchandise. On the other hand, in the second embodiment, priority information (first merchandise information) indicating a bagging priority based on weight information (first merchandise information) of merchandise or properties of the merchandise (heavy/light, hard/soft, hard to crush/easily crushed, or large/small) is detected from an input merchandise code (second merchandise information) with reference to a merchandise database, and the merchandise is sorted based on the detected weight information or priority information. In other words, in the second embodiment, the merchandise database includes information in which the merchandise code (second merchandise information) is associated with the weight information (first merchandise information) of the merchandise, and merchandise is sorted based on the weight information (first merchandise information). Alternatively, in the second embodiment, the merchandise database includes information in which the merchandise code (second merchandise information) is associated with the priority information (first merchandise information) indicating a bagging priority based on the properties of the merchandise, and merchandise is sorted based on the priority information (first merchandise information). Furthermore, the merchandise database may include information in which the merchandise code (second merchandise information) is associated with conveyance path designation information (information for designating either the first conveyance path 205 or the second conveyance path 206), and merchandise may be sorted based on the conveyance path designation information.

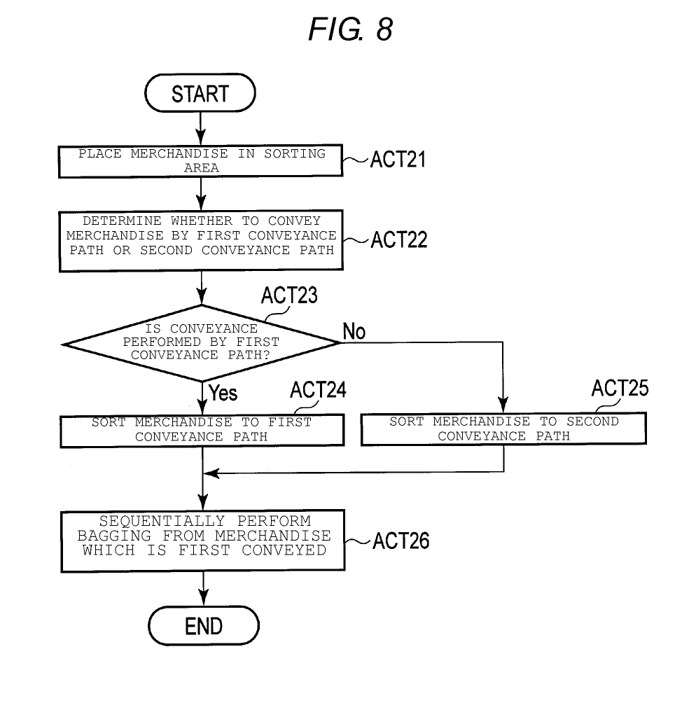

FIG. 8 is a flow chart illustrating an example of merchandise conveyance control through the merchandise management system according to the second embodiment.

For example, an operator inputs a merchandise code of each merchandise item purchased by a consumer through an operation unit 102 to carry out the transaction. The operator places merchandise having a merchandise code inputted, in the sorting area 204 (ACT 21). A control unit 101 detects weight information or priority information of merchandise from an input merchandise code with reference to a merchandise database, and controls a conveyance unit 2 based on the detected weight information or priority information. For example, the control unit 101 determines whether the weight of the merchandise is greater than a weight threshold value (whether being conveyed using a first conveyance path 205) or whether the weight of the merchandise is equal to or less than the weight threshold value (whether being conveyed using a second conveyance path 206) based on the detected weight information, with reference to the weight threshold value stored in the HDD 108 (ACT 22), and controls a sorting operation through a sorting unit 203 in accordance with the determination result. Alternatively, the control unit 101 determines whether to perform conveyance using the first conveyance path 205 or to perform conveyance using the second conveyance path 206 based on the detected priority information (ACT 22), and controls the sorting operation through the sorting unit 203 in accordance with the determination result. For example, when the detected priority information indicates a first priority, conveyance using the first conveyance path 205 is determined, and the merchandise is sorted to the first conveyance path 205 by the sorting unit 203. When the detected priority information indicates a second priority, conveyance using the second conveyance path 206 is determined, and the merchandise is sorted to the second conveyance path 206 by the sorting unit 203.

The control unit 101 outputs a first control signal for controlling the sorting to the first conveyance path 205 through the sorting unit 203 of the conveyance unit 2 in accordance with a determination result indicating that conveyance is performed using the first conveyance path 205 (ACT 23, YES). Thus, the sorting unit 203 sorts the merchandise of the sorting area to the first conveyance path 205 (ACT 24), and the first conveyance path 205 conveys the sorted merchandise to a bagging area 27.

The control unit 101 outputs a second control signal for controlling the sorting to the second conveyance path 206 through the sorting unit 203 of the conveyance unit 2 in accordance with a determination result indicating that conveyance is performed using the second conveyance path 206 (ACT 23, NO). Thus, the sorting unit 203 sorts the merchandise of the sorting area to the second conveyance path 206 (ACT 25), and the second conveyance path 206 conveys the sorted merchandise to the bagging area 27.

As described above, the merchandise is selectively conveyed on the first conveyance path 205 and the second conveyance path 206 by the operation of the sorting unit 203, and thus it is possible to variably control a timing when the merchandise arrives at a conveyance destination. In other words, merchandise to be bagged first is conveyed to the bagging area 27, and thus a consumer may perform bagging from the merchandise to be bagged first (ACT 26).

According to the above-described first and second embodiments, merchandise is sorted based on various conditions, and thus it is possible to preferentially convey desired merchandise to be bagged first to a bagging area. Thus, a consumer may efficiently perform bagging. For example, it is possible to rapidly convey heavy merchandise to a downstream side prior to light merchandise based on the weight of measured merchandise or the weight of registered merchandise. Thus, the consumer may perform bagging from heavy merchandise in order, rather than in the order of inputting merchandise codes or in an accounting process order. In addition, it is also possible to control the conveyance of merchandise based on the rigidity of registered merchandise or the size of registered merchandise. Thus, the consumer may perform bagging in the order of rigidity or size of merchandise.

In addition, an operator may input in advance a command for selecting either the first conveyance path 205 or the second conveyance path 206 to the operation unit 102 in accordance with situations such as a case of a small number of purchased merchandise items. Thus, the control unit 101 selects either the first conveyance path 205 or the second conveyance path 206 regardless of the weight of merchandise, and the like, and the merchandise is conveyed by the first conveyance path 205 or the second conveyance path 206 in a fixed manner. In this case, a consumer may selectively bag merchandise conveyed to a bagging area 207 in person.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A merchandise conveyance control device comprising:
a detection unit configured to detect first merchandise information related to conveyance control of a merchandise; and
a control unit configured to control a timing of when the merchandise is to arrive at a conveyance destination based on the first merchandise information.

2. The device according to claim 1, wherein
the detection unit is configured to measure the weight of the merchandise and the first merchandise information indicates the measured weight of the merchandise.

3. The device according to claim 2, wherein
the control unit is configured to output a first control signal to cause the merchandise to be conveyed by a first conveyance path if the control unit determines that the measured weight of the merchandise is greater than a reference weight, and to output a second control signal to cause the merchandise to be conveyed by a second conveyance path if the control unit determines that the measured weight of the merchandise is equal to or less than the reference weight.

4. The device according to claim 3, further comprising:
a sorting unit configured to direct the merchandise to the first conveyance path if the control unit outputs the first control signal, and to direct the merchandise to the second conveyance path if the control unit outputs the second control signal.

5. The device according to claim 1, wherein
the detection unit is configured to receive an input of second merchandise information which is correlated to the first merchandise information.

6. The device according to claim 5, wherein the first merchandise information indicates a weight of the merchandise.

7. The device according to claim 6, wherein
the control unit is configured to output a first control signal to cause the merchandise to be conveyed by a first conveyance path if the control unit determines that the weight of the merchandise is greater than a reference weight, and to output a second control signal to cause the merchandise to be conveyed by a second conveyance if the control unit determines that the weight of the merchandise is equal to or less than the reference weight.

8. The device according to claim 5, wherein the first merchandise information indicates a bagging priority of the merchandise.

9. The device according to claim 8, wherein
the control unit is configured to output a first control signal to cause the merchandise to be conveyed by a first conveyance path if the control unit determines that the bagging priority of the merchandise is a first priority, and to output a second control signal to convey the merchandise to be conveyed by a second conveyance path if the control unit determines that the bagging priority of the merchandise is a second priority.

10. The device according to claim 1, further comprising a conveyance unit configured to convey the merchandise to the conveyance destination.

11. The device according to claim 10, wherein the conveyance unit includes first and second conveyance belts that move at different speeds.

12. A merchandise conveyance control method comprising:
detecting first merchandise information related to conveyance control of a merchandise; and
controlling a timing of when the merchandise is to arrive at a conveyance destination based on the first merchandise information.

13. The method according to claim 12, wherein said detecting includes measuring the weight of the merchandise, and the first merchandise information indicates the measured weight of the merchandise.

14. The method according to claim 13, further comprising:
generating a first control signal to cause the merchandise to be conveyed by a first conveyance path if the measured weight of the merchandise is greater than a reference weight; and
generating a second control signal to cause the merchandise to be conveyed by a second conveyance path if the measured weight of the merchandise is equal to or less than the reference weight.

15. The method according to claim 12, wherein said detecting includes receiving an input of second merchandise information which is correlated to the first merchandise information.

16. The method according to claim 15, wherein the first merchandise information indicates a weight of the merchandise.

17. The method according to claim 16, further comprising:
generating a first control signal to cause the merchandise to be conveyed by a first conveyance path if the weight of the merchandise is greater than a reference weight; and
generating a second control signal to cause the merchandise to be conveyed by a second conveyance path if the weight of the merchandise is equal to or less than the reference weight.

18. The method according to claim 15, wherein the first merchandise information indicates a bagging priority of the merchandise.

19. The method according to claim 18, further comprising:
generating a first control signal to cause the merchandise to be conveyed by a first conveyance path if the bagging priority of the merchandise is a first priority; and
generating a second control signal to cause the merchandise to be conveyed by a second conveyance path if the bagging priority of the merchandise is a second priority.

20. The method according to claim 12, further comprising:
conveying the merchandise to the conveyance destination using one of first and second conveyance belts that move at different speeds.
